(19) United States
(12) Patent Application Publication
(10) Pub. No.: US 2009/0230862 A1
(43) Pub. Date: Sep. 17, 2009

(54) Substrate Assembly for Plasma Display Panel and Display Panel

(75) Inventor: Koji Sugawa, Miyazaki (JP)

Correspondence Address: MILES & STOCKBRIDGE PC, 1751 PINNACLE DRIVE, SUITE 500, MCLEAN, VA, 22102-3833, US

(73) Assignee: FIJITSU HITACHI PLASMA DISPLAY LIMITED, Miyazaki (JP)

(21) Appl. No.: 12/090,355

(22) PCT Filed: Dec. 19, 2005
(86) PCT No.: PCT/JP2005/023292

§ 371 Date: Apr. 15, 2008

(51) Int. Cl. H01J 17/49

(52) U.S. Cl. 313/582

(57) ABSTRACT

The present invention provides a substrate assembly for a PDP which can prevent vacuum ultraviolet rays from reaching a dielectric layer and a protective layer from peeling off.

A substrate assembly for a PDP of the present invention includes display electrodes, a first dielectric layer covering the display electrodes, a shield layer for shielding vacuum ultraviolet rays, a second dielectric layer and a protective layer stacked in this order on a substrate.

### TECHNICAL FIELD

The present invention relates to a substrate assembly for a plasma display panel (hereinafter, referred to as PDP) and a PDP.

### BACKGROUND ART

In FIG. 4, a perspective view of a schematic structure of a common PDP is shown. The PDP has a structure formed by sticking a front-side substrate assembly 1 and a rear-side substrate assembly 2 to each other. The front-side substrate assembly 1 comprises a glass substrate 1a, display electrodes 3 each composed of a transparent electrode 31 and a bus electrode 32 and placed on the substrate 1a, and a dielectric layer 4 covering the display electrodes 3. Further, a protective layer 5, which is a magnesium oxide layer, with a high secondary electron emission coefficient is formed on the dielectric layer 4. In the rear-side substrate assembly 2, address electrodes 6 are placed on a glass substrate 2a, so that the address electrodes 6 cross at a right angle to the display electrodes, and barrier ribs 7 for defining the light emitting regions are formed between neighboring address electrodes 6, and red-, green-, and blue-emitting phosphor layers 8 are formed on the address electrodes 6 in the regions divided by the barrier ribs 7. A Ne—Xe gas mixture is introduced in the insides between the front-side substrate assembly 1 and the rear-side substrate assembly 2 stuck to each other.

The aspect of discharge of a discharge cell viewed from a cross section is shown in FIG. 5. If a voltage is applied between the display electrodes 3 composed of a pair of electrodes X and Y and thereby an electric field is applied to a discharge space, a Xe gas is excited to generate a gas discharge 9 and vacuum ultraviolet rays 10 are emitted from the discharge. The vacuum ultraviolet rays 10 impinge on the phosphors 8 to emit visible light. 11. The PDP operates as a display by controlling the vacuum ultraviolet rays 10 with an electric field in the cell. In this time, the vacuum ultraviolet rays 10 are irradiated not only to the phosphors 8 but also to the front-side substrate assembly 1. Though the protective layer (MgO) 5 and the dielectric layer 4 are formed in this order from a discharge surface side on the glass substrate 1a of the front-side substrate assembly 1, a part of the vacuum ultraviolet rays 10 reaches the dielectric layer 4 since MgO transmits a part of the vacuum ultraviolet rays 10 with a wavelength of 165 nm or larger.

When the dielectric layer 4 is made of a material which transmits vacuum ultraviolet rays, the vacuum ultraviolet rays 10 pass through the dielectric layer 4. During this passing, impurity gas mainly containing undecomposed substances (H₂, NH₃ etc.) in the dielectric layer is generated by energy of the vacuum ultraviolet rays 10, and this gas may have a detrimental effect on the discharge characteristics or the life of a PDP.

In the PDP described in Patent Document 1, the vacuum ultraviolet rays 10 are prevented from reaching the dielectric layer 4 by providing, between the protective layer 5 and the dielectric layer 4, an intermediate layer made of ZrO₂ or the like having a function of shielding vacuum ultraviolet rays.

Patent Document 1: Japanese Patent Application Laid-Open No. 2004-71338

### DISCLOSURE OF THE INVENTION

### Problems to be Solved by the Invention

However, good adhesion was not necessarily achieved between the intermediate layer and the protective layer 5 and there might be cases where the protective layer 5 peeled off.

The present invention has been achieved in view of the above-mentioned circumstances and provides a substrate assembly for a PDP which can prevent vacuum ultraviolet rays from reaching a dielectric layer and a protective layer from peeling off.

### Means for Solving the Problems and Effect of the Invention

The substrate assembly for a PDP of the present invention includes display electrodes, a first dielectric layer covering the display electrodes, a shield layer for shielding vacuum ultraviolet rays, a second dielectric layer and a protective layer stacked in this order on a substrate.

In accordance with the present invention, since the second dielectric layer is provided between the protective layer and the shield layer, the peeling of the protective layer resulting from the low adhesion between the protective layer and the shield layer can be prevented.

### BRIEF DESCRIPTION OF THE DRAWINGS

FIG. 1 is a sectional view showing a structure of a front substrate for a PDP of a first embodiment of the present invention.

FIG. 2 is a sectional view showing a structure of a front substrate for a PDP of a second embodiment of the present invention

FIG. 3 is a graph showing the results of a test of the changes in intensity in Example 1 and Comparative Example 2 of the present invention.

FIG. 4 is a schematic perspective view of a conventional PDP.

FIG. 5 is a schematic view showing the aspect of discharge of a gas discharge panel according to the conventional PDP.

### DESCRIPTION OF THE REFERENCE NUMERALS AND SYMBOLS

1: front-side substrate assembly 1a: front glass substrate 2: rear-side substrate assembly 2a: rear glass substrate 3: display electrodes 31: transparent electrodes 32: bus electrodes 4: dielectric layer 5: protective layer 6: address electrodes 7: barrier ribs 8: phosphor layers 9: gas discharge 10: vacuum ultraviolet rays 11: visible light 12: substrate 13: display electrodes 15: first dielectric layer 17: shield layer 19: second dielectric layer 21: protective layer X and Y: pair of display electrodes

### BEST MODE FOR CARRYING OUT THE INVENTION

Hereinafter, an embodiment of the present invention will be described with reference to drawings. The drawings are used for convenience sake of description and accordingly, the present invention is not to be considered as being limited by the embodiments shown in drawings.

In the following embodiments, the present invention will be described by exemplifying the case where display electrodes, a dielectric layer and a protective layer are provided on a front-side substrate. In the following embodiments and Examples, the front-side substrate assembly is also referred to as a front substrate.

The present invention can be embodied primarily in two embodiments described below.

### 1. First Embodiment

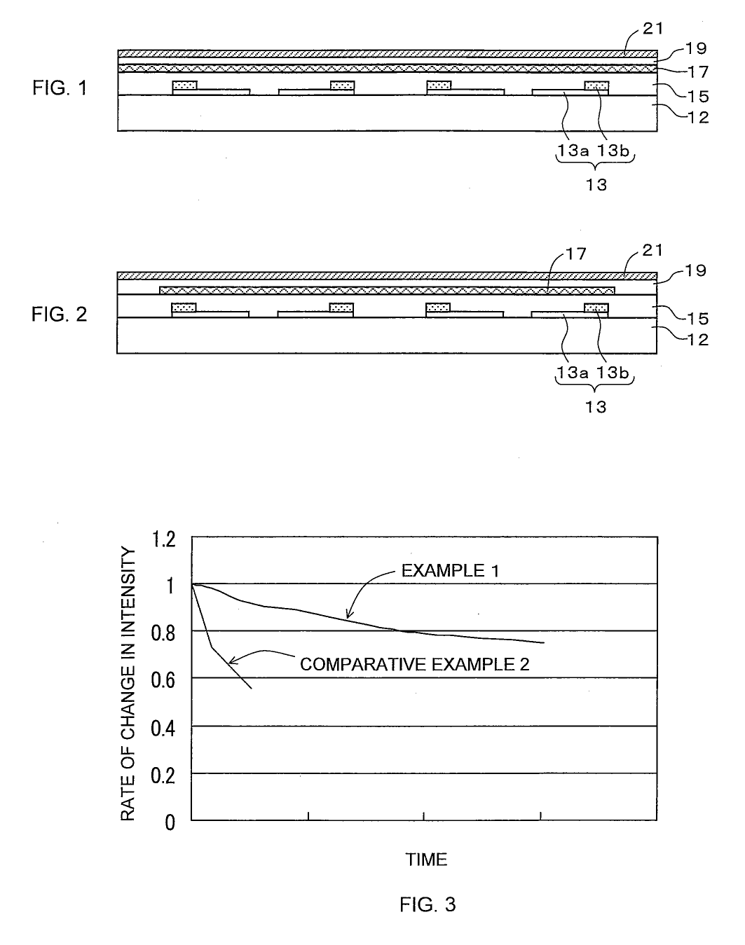

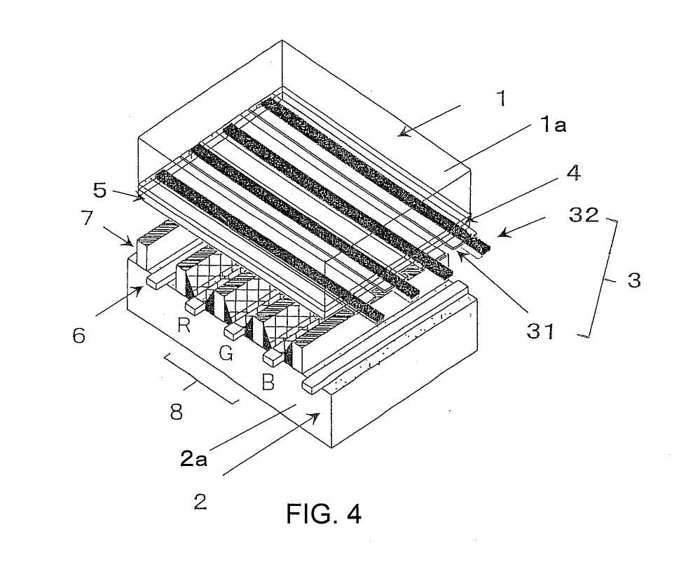

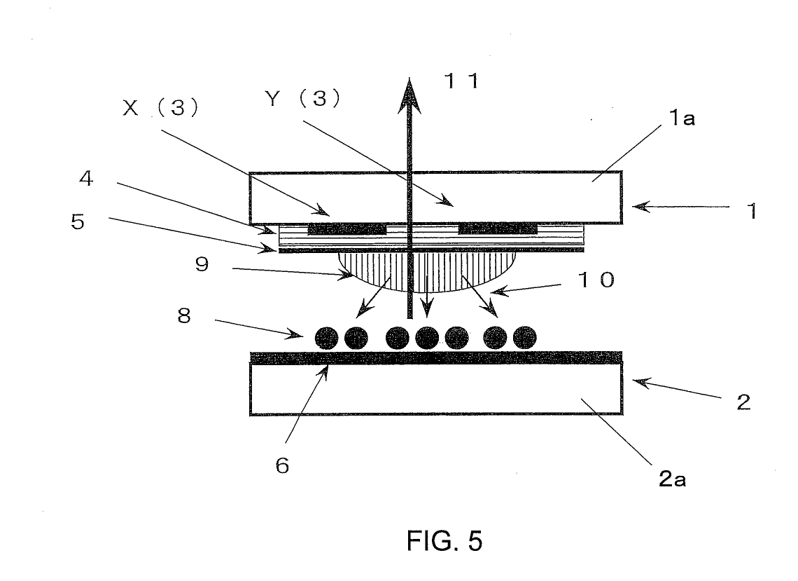

FIG. 1 is a sectional view showing a structure of a front substrate for a PDP of a first embodiment of the present invention. The front substrate of this embodiment includes display electrodes 13, a first dielectric layer 15 covering the display electrodes 13, a shield layer 17 for shielding vacuum ultraviolet rays, a second dielectric layer 19 and a protective layer 21 stacked in this order on a substrate 12. In this embodiment, the second dielectric layer 19 acts as an adhesive layer between the shield layer 17 and the protective layer 21. Therefore, a material of the second dielectric layer 19 is selected so as to have high adhesion to both the shield layer 17 and the protective layer 21. By sandwiching the second dielectric layer 19 between the shield layer 17 and the protective layer 21, the adhesion among the shield layer 17, the second dielectric layer 19 and the protective layer 21 is enhanced and the peeling of the protective layer 21 can be prevented.

The substrate 12 is not particularly limited, and any substrate which is known in the art can be used. Specific examples of the substrate include transparent substrates such as a glass substrate, a plastic substrate and the like.

As the display electrodes 13, electrodes made of transparent electrode materials such as ITO, and SnO₂ and electrodes made of metal electrode materials such as Ag, Au, Al, Cu, and Cr, or the like, may be employed. Specifically, electrodes each composed of a transparent electrode 13a with a wide width made of materials such as ITO, or SnO₂ and a bus electrode 13b with a narrow width made of a metal such as Ag, Au, Al, Cu, Cr or laminates thereof (for example, Cr/Cu/Cr laminate structure) for reducing the resistance of the electrode are employed. Desired number of the display electrodes 13 with desired thickness, width, and spacing may be formed by employing a printing method for Ag and Au and combining a film formation method such as a vapor deposition method, a sputtering method or the like with an etching method for the other materials.

The first dielectric layer 15 can be formed from silicon oxide (SiO₂), magnesium fluoride (MgF₂), lithium fluoride (LiF), potassium chloride (KCl) or the like. Since these materials transmit the vacuum ultraviolet rays, the problem of impurity gas described in a paragraph of BACKGROUND ART can arise, but in accordance with the present invention, it is possible to prevent the occurrence of such a problem. The first dielectric layer 15 is formed, for example, in a thickness of 5 to 15 μm. The first dielectric layer 15 can be formed by a chemical vapor deposition (CVD) method, a sputtering method, or the like.

The shield layer 17 is formed from a material which does not transmit the vacuum ultraviolet rays, specifically light with a wavelength of 190 nm or less. For example, the shield layer 17 is made of at least one selected from the group consisting of zirconium (Zr) compounds, aluminum (Al) compounds, titanium (Ti) compounds, yttrium (Y) compounds, zinc (Zn) compounds, low melting point glass, silicon carbide (SiC), and silicon nitride (SiN). That is, the shield layer 17 may be made of any one of these substances, or may be made of a mixture of any two or more of these substances. Examples of the Zr compounds include zirconium oxide (ZrO₂), zirconium nitride, and the like, examples of the Al compounds include alumina, aluminum nitride, and the like, examples of the Ti compounds include titania, titanium nitride, and the like, examples of the Y compounds include yttrium oxide, yttrium nitride, and the like, and examples of the Zn compounds include zinc oxide, zinc nitride, zinc sulfide, and the like. The shield layer 17 is formed, for example, in a thickness of 0.1 to 1 μm, and preferably in a thickness of 0.3 to 0.4 μm. The shield layer 17 can be formed by a sputtering method, a vapor deposition method, a sol-gel method, a binder method, or the like.

The second dielectric layer 19 can be formed from the same materials and method as those in the descriptions of the first dielectric layer 15. The materials for forming the second dielectric layer 19 may be identical to or different from those of the first dielectric layer 15. Since the second dielectric layer 19 is exposed to the vacuum ultraviolet rays, the second dielectric layer 19 is preferably formed in a thickness smaller than the first dielectric layer 15 in order to inhibit the generation of impurity gas, and it is preferably formed in a thickness of one-tenth or less (for example, one-twentieth or less, fiftieth or less) of that of the first dielectric layer 15. The second dielectric layer 19 preferably has a thickness of 1 μm or less (for example, 0.5 μm or less, 0.2 μm or less). The second dielectric layer 19 is preferably formed in a thickness of 0.01 μm or more (for example, 0.02 μm or more, 0.05 μm or more). The reason for this is that when this thickness is too small, the second dielectric layer 19 may not properly exert its function.

By the way, in this embodiment, the substrate assembly has two dielectric layers, but in another embodiment, it may have three or more dielectric layers.

The protective layer 21 has a function of protecting the second dielectric layer 19 from damages caused by impingement of ions produced by discharge generated in displaying. The protective layer 21 is composed of, for example, MgO, CaO, SrO, BaO or the like. A thickness of the protective layer 21 is selected to be, for example, 0.5 to 1.5 μm. The protective layer 21 can be formed by a sputtering method, a vapor deposition method, or the like.

### 2. Second Embodiment

FIG. 2 is a sectional view showing a structure of a front substrate for a PDP of a second embodiment of the present invention. In the front substrate of this embodiment, a shield layer 17 is formed in a smaller area than areas of the first dielectric layer 15 and the second dielectric layer 19 so that the shield layer 17 is enveloped in the first dielectric layer 15 and the second dielectric layer 19. Accordingly, the first dielectric layer 15 contacts the second dielectric layer 19 outside the periphery of the shield layer 17. Put another way, the shield layer 17 is embedded in a dielectric layer composed of the first dielectric layer 15 and the second dielectric layer 19. The first dielectric layer 15 is in close contact with the second dielectric layer 19 and the shield layer 17 is held between both dielectric layers. Materials of the first dielectric layer 15 and the second dielectric layer 19 are selected so as to have high adhesion to each other. From this viewpoint, the first dielectric layer 15 is preferably formed from the same material as that of the second dielectric layer 19. Further, in order to effectively prevent the peeling of the protective layer 21, a material having high adhesion to the protective layer 21 is selected as the material of the second dielectric layer 19.

The materials and the production methods of the respective layers described in the first embodiment hold true in principle for the second embodiment.

### (Others)

The various characteristics described in the above embodiments may be combined. In the case where a plurality of characteristics are included in one embodiment, one or a plurality of these characteristics may be appropriately picked up and employed alone or in combination for the present invention.

In the above embodiment, the present invention has been described by exemplifying the case where the display electrodes, the dielectric layer, the protective layer, and the like, are formed on the front-side substrate, but in a inverted panel configuration in which these members are formed on the rear-side substrate, the present invention can also be embodied.

### 3. PDP

A PDP can be produced by sticking the rear-side substrate assembly (rear substrate) and the front-side substrate assembly (front substrate) to each other with a sealing material and introducing/encapsulating a discharge gas in a discharge spaces. The PDP can be produced according to, for example, the method described in Patent Document 1. By employing the substrate assembly of the present invention, it is possible to obtain the PDP of the present invention, for example an AC type PDP, including display electrodes 13 for generating surface-discharge, a first dielectric layer 15 covering the display electrodes 13, and a protective layer 21 for protecting the surface of the first dielectric layer 15, which are formed on the front-side substrate 12, characterized in that a shield layer 17 for shielding vacuum ultraviolet rays is formed between the first dielectric layer 15 and the protective layer 21 and a second dielectric layer 19 is formed between the shield layer 17 and the protective layer 21 to sandwich the above-mentioned shield layer 17 between the first dielectric layer 15 and the second dielectric layer 19.

### EXAMPLES

### 3-1. Preparation of Front Substrate

### Example 1

(1) After forming transparent electrodes and bus electrodes on a glass substrate, a first dielectric layer made of SiO₂ was formed in a thickness of 10 μm under the following conditions.

Apparatus: parallel plate plasma CVD apparatus

Species of gas/flow rate: SiH₄/8000 sccm, N₂O/110000 sccm

RF power: 17 kW

Substrate temperature: 450° C.

Degree of vacuum: 2.5 Torr

(2) Next, a shield layer made of ZrO₂ was formed in a thickness of 0.3 μm under the following conditions.

Apparatus: electron beam vapor deposition apparatus

Degree of vacuum: 10⁻⁶ Torr

Power source: 1.5 kW, 150 mA

(3) Then, a second dielectric layer made of SiO₂ was formed in a thickness of 0.1 μm under the following conditions.

Apparatus: parallel plate plasma CVD apparatus

Species of gas/flow rate: SiH₄/3000 sccm, N₂O/40000 sccm

RF power: 7 kW

Substrate temperature: 450° C.

Degree of vacuum: 3 Torr

(4) Next, a protective layer made of MgO was formed in a thickness of 0.8 μm under the following conditions to prepare a front substrate.

Degree of vacuum: 4×10⁻⁷ Torr

Power source: 1.5 kW, 150 mA

Temperature: 150° C.

(5) The shield layer was formed so as to be enveloped in the first dielectric layer and the second dielectric layer like the second embodiment. The peeling of the protective layer did not occur immediately after the film formation.

### Comparative Example 1

### A Second Dielectric Layer is not Provided

A first dielectric layer, a shield layer and a protective layer were formed under the same conditions as in Example 1 to prepare a front substrate. A second dielectric layer was not formed. As a result of this, the peeling of the protective layer occurred immediately after the film formation.

### Comparative Example 2

### A Shield Layer is not Provided

A first dielectric layer and a protective layer were formed under the same conditions as in Example 1 to prepare a front substrate. A shield layer and a second dielectric layer were not formed. The peeling of the protective layer did not occur immediately after the film formation.

### 3-2. Preparation of PDP and Test of Changes in Intensity

A PDP was prepared according to the method described in Patent Document 1 using the front substrates in Example 1 and Comparative Example 2. A test of the changes in intensity was carried out on each of the prepared PDPs. The results of the test are shown in FIG. 3. It is found from FIG. 3 that the intensity in using the substrate in Example 1 is decreased significantly more slowly than that in using the substrate in Comparative Example 2. The reason for this is thought to be by virtue of inhibiting the generation of impurity gas by the shield layer provided in Example 1.

### 3-3. Add-Up

From the above descriptions, it has been found that in accordance with the PDP of the present invention, it is possible to prevent the peeling of the protective layer and to inhibit the generation of impurity gas from the dielectric layer due to the vacuum ultraviolet rays.

1. A substrate assembly for a plasma display panel comprising display electrodes, a first dielectric layer covering the display electrodes, a shield layer for shielding vacuum ultraviolet rays, a second dielectric layer, and a protective layer stacked in this order on a substrate.

2. The substrate assembly of claim 1, wherein the shield layer is formed in a smaller area than those of the first and the second dielectric layers so that the shield layer is enveloped in the first and the second dielectric layers.

3. The substrate assembly of claim 2, wherein the first and the second dielectric layers are formed of the same material.

4. The substrate assembly of claim 1, wherein the second dielectric layer has a thickness of one-tenth or less of that of the first dielectric layer.

5. The substrate assembly of claim 1, wherein the first and the second dielectric layers are made of SiO₂.

6. The substrate assembly of claim 1, wherein the shield layer is made of at least one selected from the group consisting of Zr compounds, Al compounds, Ti compounds, Y compounds, Zn compounds, low melting point glass, SiC, and SiN.

7. The substrate assembly of claim 1, wherein the shield layer is made of ZrO₂.

8. The substrate assembly of claim 1, wherein the protective layer is made of MgO.

9. An AC type plasma display panel comprising display electrodes for generating surface-discharge, a first dielectric layer covering the display electrodes, and a protective layer for protecting the surface of the first dielectric layer, wherein a shield layer for shielding vacuum ultraviolet rays is formed between the first dielectric layer and the protective layer and a second dielectric layer is formed between the shield layer and the protective layer to sandwich the shield layer between the first and the second dielectric layers.
